(19) United States
(12) Patent Application Publication
(10) Pub. No.: US 2025/0062660 A1
(43) Pub. Date: Feb. 20, 2025

(54) ATTACHMENT COOLER OF A DYNAMO-ELECTRIC MACHINE WITH PLATE COOLERS

(71) Applicant: Innomotics GmbH, 90441 Nürnberg (DE)

(72) Inventors: ERIK KROMPASKY, Nucice (CZ); ONDREJ LUÑÁCEK, Prague (CZ); MARTIN RÚT, Celakovice (CZ)

(73) Assignee: Innomotics GmbH, 90441 Nürnberg (DE)

(21) Appl. No.: 18/720,296

(22) PCT Filed: Nov. 8, 2022
(86) PCT No.: PCT/EP2022/081066

§ 371 Date: Jun. 14, 2024

(30) Foreign Application Priority Data
Dec. 15, 2021 (EP) 21214794.6

(51) Int. Cl. H02K 9/16; H02K 9/22; H02K 11/25

(52) U.S. Cl. CPC H02K 9/16; H02K 9/227; H02K 11/25; H02K 2213/12

(57) ABSTRACT

An attachment cooler of a dynamo-electric machine is embodied as a heat exchanger and includes a primary circuit for flow of a medium, and a secondary circuit separate from the primary circuit for flow of a medium, with the secondary circuit including a central channel and a waste air channel. A casing includes receiving openings and is designed to accommodate the central channel and the waste channel of the secondary circuit, with the waste channel leading out to a side of the casing. Exchangeable modules embodied as plate heat exchangers are insertable in the receiving openings of the casing. Each of the modules is designed for individual removal, without a flow bypass being created by unoccupied ones of the receiving openings.

The invention relates to an attachment cooler of a closed dynamo-electric machine, to a dynamo-electric machine, to a method for cooling a dynamo-electric machine, and also to the use of a dynamo-electric machine.

Dynamo-electric machines give rise to losses during operation that must be overcome in order to be able to guarantee an orderly operation of the dynamo-electric machine.

In such cases various cooling media are basically employed, such as gas, in particular air, or liquids, in particular water.

In closed dynamo-electric machines an inner closed cooling circuit (primary circuit) is present, in which in particular air or another medium is circulated. The cooling down of this medium of the primary circuit is undertaken in this case in a heat exchanger (secondary circuit), which is arranged on the machine.

Essentially, inter alia, there are two known air cooler principles for these closed dynamo-electric machines. On the one hand the tube bundle air-to-air heat exchanger. A disadvantage is the comparatively large volume required for this and the cost of manufacturing. A required cleaning of the respective tubes of the tube bundle air-to-air heat exchanger to maintain the cooling performance is extremely complex. Moreover, a symmetrical, even cooling of the dynamo-electric machine is almost impossible.

Furthermore, air-to-air plate heat exchangers are basically known from WO 01/05017 A1 and WO 2016/046407 A1. The disadvantage of these is the comparatively complex structure and a complicated guidance of the air.

Using this as its starting point, the underlying object of the invention is to avoid the aforementioned disadvantages and to provide an attachment cooler of a dynamo-electric machine that has comparatively simple air guidance and is able to be adapted to the required heat loads of the dynamo-electric machine.

The desired object is successfully achieved by an attachment cooler of a dynamo-electric machine, which has a stator with a winding system and a rotor mounted rotatably about an axis,
wherein the attachment cooler is embodied as a heat exchanger, which has a primary circuit and a secondary circuit separated therefrom in terms of flow,
wherein the attachment cooler has a casing with receiving openings, into which exchangeable modules which are designed as plate heat exchangers can be inserted,
wherein the casing of the attachment cooler has an, in particular, axially parallel, central channel of the secondary circuit, which in particular runs in the center of the casing, and a waste air channel of the secondary circuit leads out of the side of the casing, in particular perpendicular to a supply air channel.

The desired object is also successfully achieved by a dynamo-electric machine with an inventive attachment cooler, wherein a casing of the dynamo-electric machine has openings that correspond to supply air and waste air openings of the attachment cooler in such a way that a primary circuit, which is able to be cooled down again by a cooling airflow of the secondary circuit is set up.

The desired object is also successfully achieved by a method for cooling a dynamo-electric machine provided with an inventive attachment cooler, wherein the cooling temperature in a primary circuit and/or in a secondary circuit are detected by means of sensors, this data is transferred to a closed-loop control apparatus in order to control the speed of separate fans and/or to set control apparatuses.

The desired object is also successfully achieved by a use of a dynamo-electric machine with an inventive attachment cooler for example for compressors or pumps.

In accordance with the invention an attachment cooler now provides a comparatively more efficient cooling system for dynamo-electric machines which, by virtue of its modular design, is suitable for a primary circuit of one-sided and two-sided ventilation systems of dynamo-electric machines.

The modular structure of the plate heat exchanger in the attachment cooler means that a simple exchange of the individual modules for overhaul, cleaning etc. is possible. The inventive use of exchangeable modules as plate heat exchangers in an attachment cooler allows the cooling efficiency to be increased by up to 20% compared with known cooling methods. Furthermore, a reduction in noise emissions is also guaranteed with this.

Advantageously, low-cost standardized modules can also be employed as plate heat exchangers.

The individual modules weigh comparatively little, so that they can be installed in the attachment cooler or removed from the attachment cooler without the assistance of a crane.

The use of modules enables modules to be inserted in the same casing of the attachment cooler that work on either the crossflow or counterflow basis. This leads to an adaptation to the application purpose and/or required cooling performance of the attachment cooler.

The attachment cooler and in particular the modules with their plates are of simple construction and are thus easy to clean. Furthermore, the modules or the plate heat exchangers can be designed to be corrosion-resistant and resistant to salt. In this case the plates of the modules can be made of a material with comparatively good thermal conductivity, such as, for example, aluminum, also with a very wide variety of coatings, and also of stainless steel.

The resistance to chemicals of the attachment cooler can be improved by the use of coated plates in each of the modules of the plate heat exchanger. The coating required in each case can be adapted in such cases to the requirements of resistance to chemicals or to the purpose for which the attachment cooler arranged on the machine is to be used.

A primary circuit, independent of one-sided or two-sided ventilation within the dynamo-electric machine, refers to the airflow or airflow distribution that flows onto or around components of the machine, such as winding head space, winding head, laminated core, windings, casing, bearings etc. and is designed as a closed circuit that has no contact with the outside in terms of flow. The airflow of the primary circuit is generated by one or more integral fans and/or separate fans blowing or sucking.

The airflow in the attachment cooler, which is coupled in terms of heat to the airflow of the primary circuit, thus can cool it back down, is referred to as a secondary circuit, wherein the airflow or airflow distribution of the secondary circuit is generated by integral fans and/or separate fans blowing or sucking.

Preferably, the secondary circuit is designed to be open, i.e. it is operated with ambient air that is sucked in from the environment and is discharged again heated up to the environment. This enables a dynamo-electric machine equipped with an attachment cooler of this type to be placed at almost any given location. Where necessary filter mats or air filters are to be provided before the secondary circuit for heavily contaminated air.

In this case each airflow of both the primary circuit and also of the secondary circuit can be divided up, at least in sections within the course of its flow, into parallel flow paths, in particular during the exchange of heat between primary circuit and secondary circuit. Advantageously this is undertaken by guide apparatuses in the dynamo-electric machine and/or in the attachment cooler in order to optimize the cooling effect of the flow of primary circuit and/or secondary circuit.

In one version the operation of the dynamo-electric machine must not be interrupted during maintenance of individual modules, since the cooling is undertaken via the remaining modules. A corresponding loss of cooling performance merely has to be reckoned with.

The invention, as well as further advantageous embodiments of the invention will be explained in greater detail with the aid of exemplary embodiments shown in principle, in which:

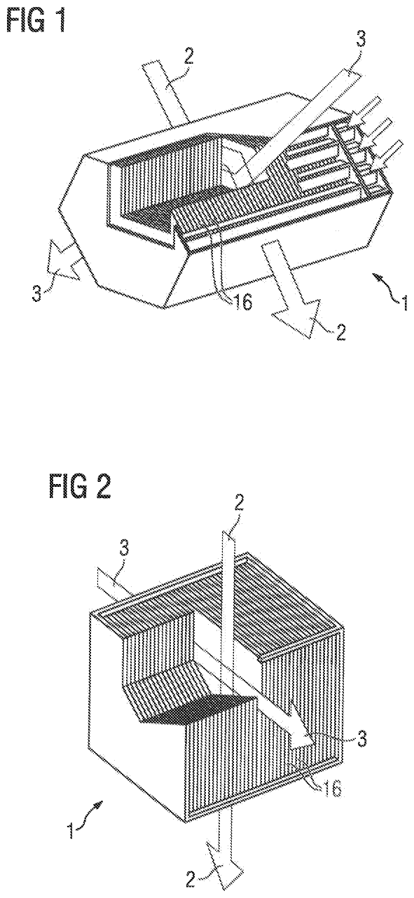

FIGS. 1, 2 show various versions of plate coolers,

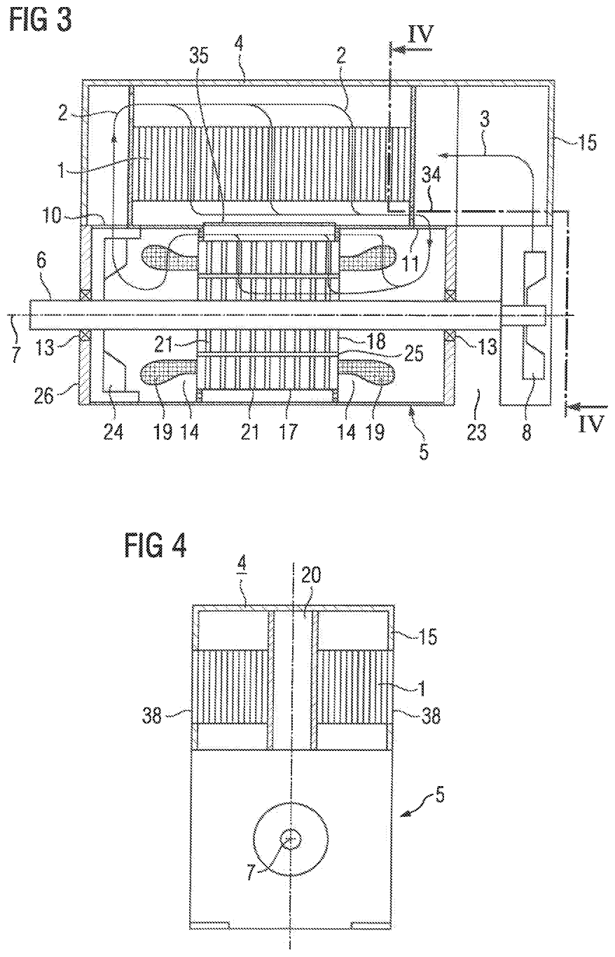

FIG. 3 shows a longitudinal section of a dynamo-electric machine with attachment cooler,

FIG. 4 shows a cross-section of a dynamo-electric machine with attachment cooler,

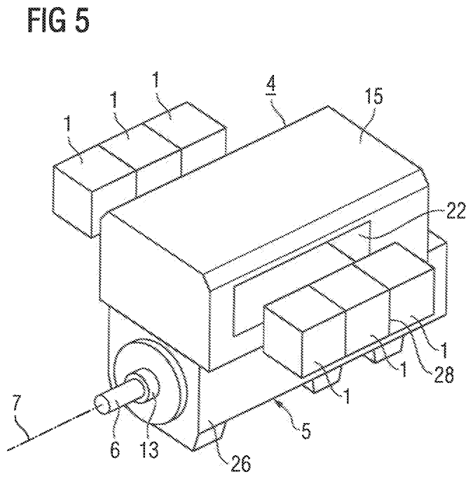

FIG. 5 shows a perspective diagram of a dynamo-electric machine with attachment cooler,

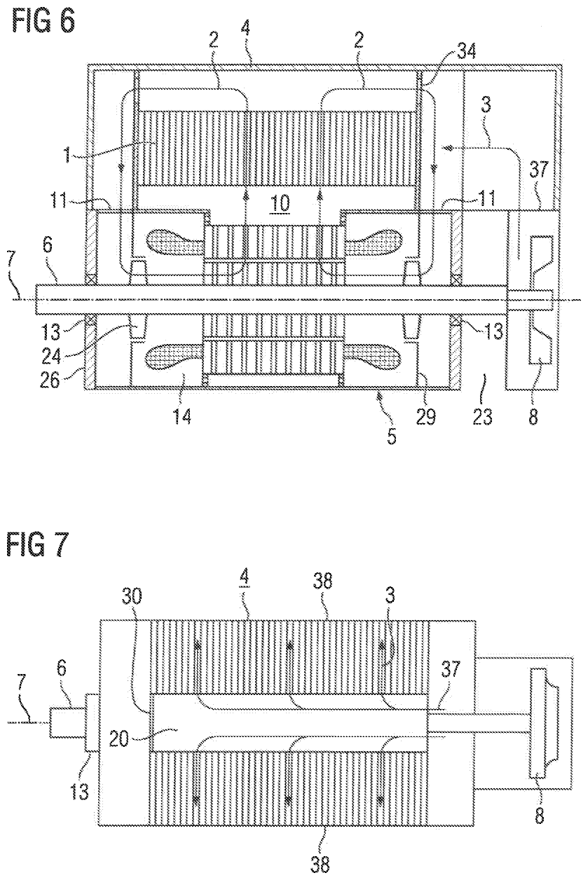

FIG. 6 shows a longitudinal section of a dynamo-electric machine with attachment cooler with a basic primary circuit and secondary circuit,

FIG. 7 shows an overhead view of an attachment cooler with basic secondary circuit,

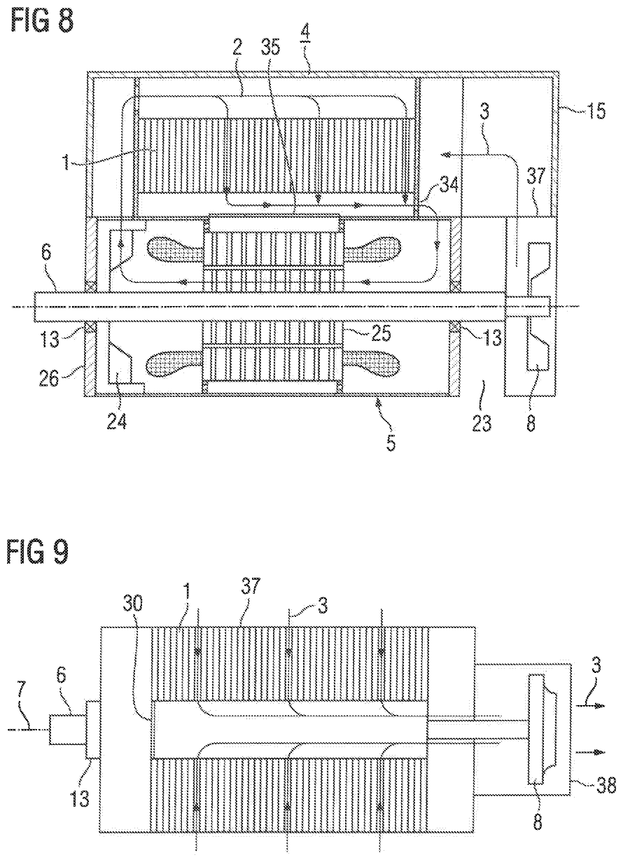

FIG. 8 shows a longitudinal section of a dynamo-electric machine with attachment cooler with a further basic primary circuit and secondary circuit,

FIG. 9 shows an overhead view of an attachment cooler with basic secondary circuit,

FIG. 10 shows a longitudinal section of a dynamo-electric machine with attachment cooler with a further basic primary circuit and secondary circuit,

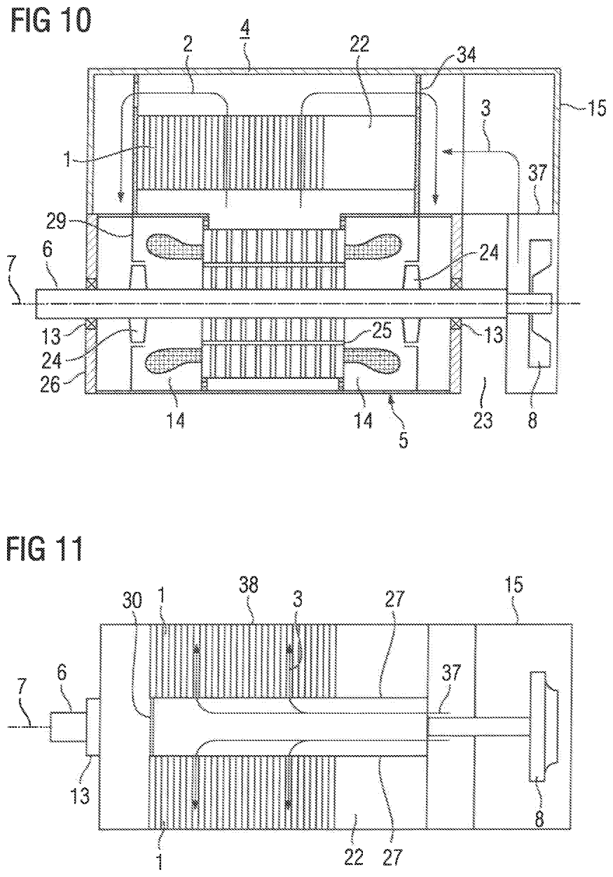

FIG. 11 shows an overhead view of an attachment cooler with basic secondary circuit,

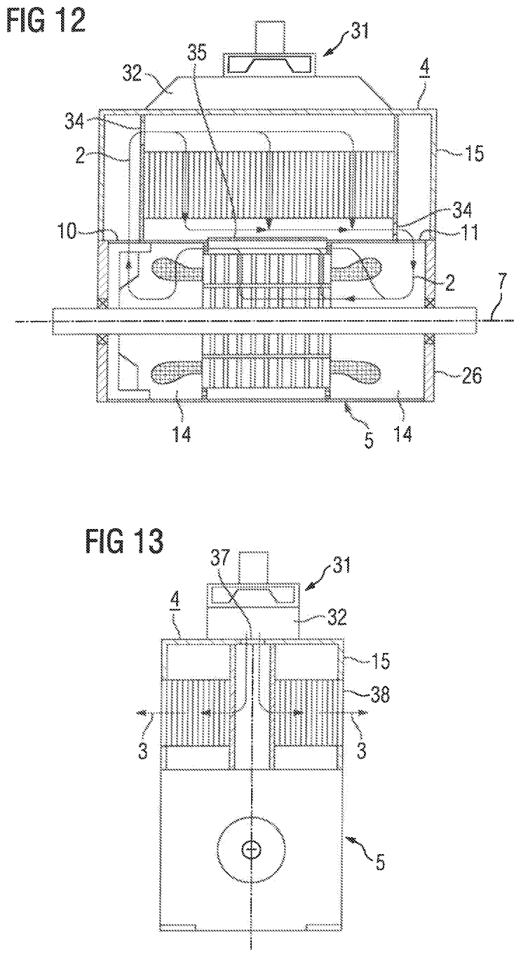

FIG. 12 to FIG. 20 show arrangements of separate fans on a dynamo-electric machine with attachment cooler,

FIG. 21 to FIG. 24 show arrangements of modules in the attachment cooler,

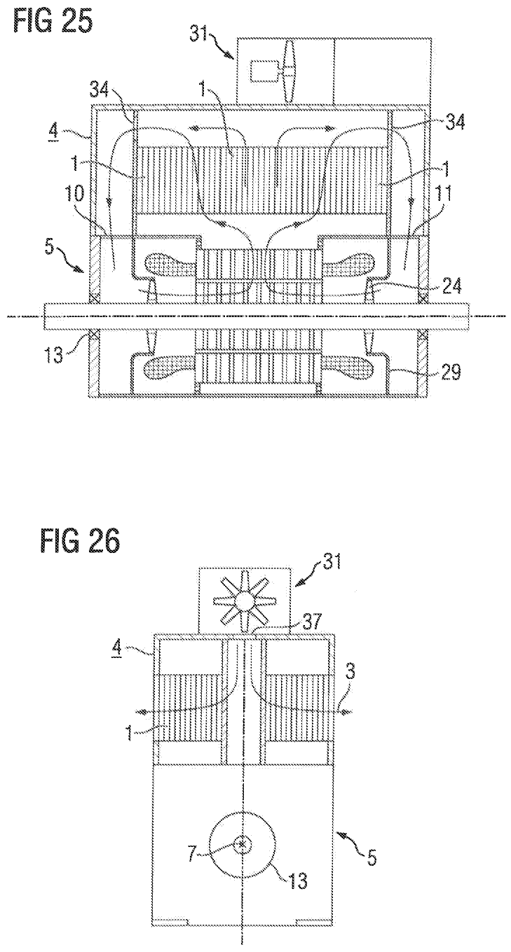

FIGS. 25, 26 show an arrangement of a separate fan on the attachment cooler for an internal two-sided ventilation of a dynamo-electric machine,

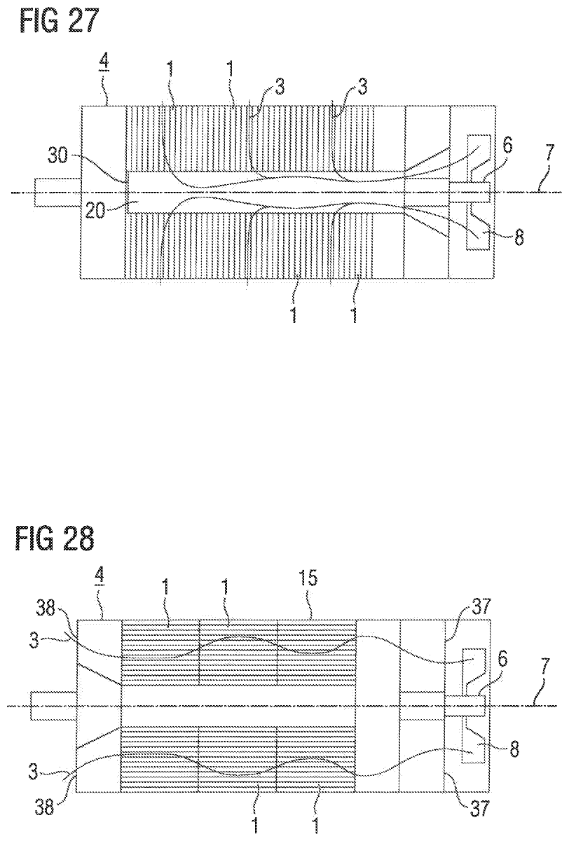

FIGS. 27, 28 show basic throughflow directions of the modules of the attachment cooler,

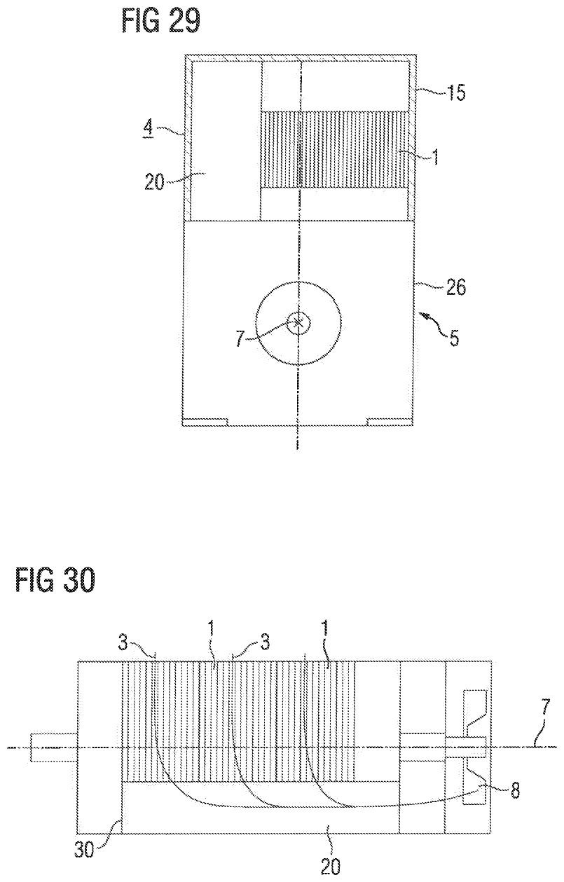

FIGS. 29, 30 show an asymmetrical structure of an attachment cooler,

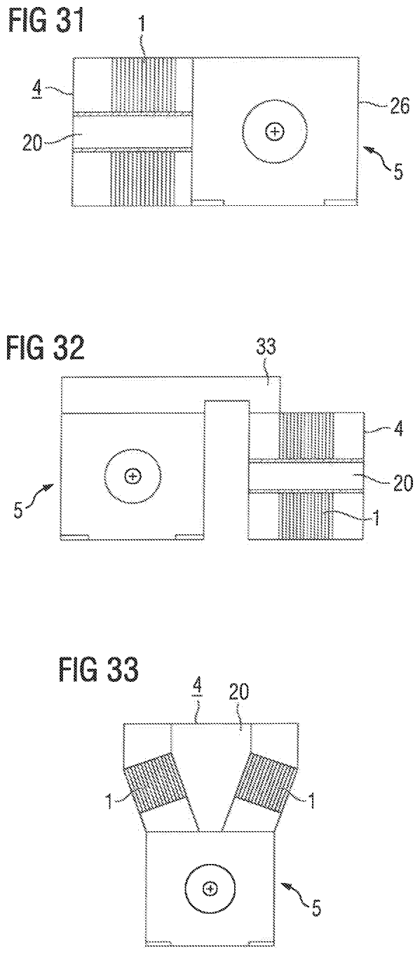

FIG. 31 to FIG. 33 show arrangements of attachment cooler on a dynamo-electric machine,

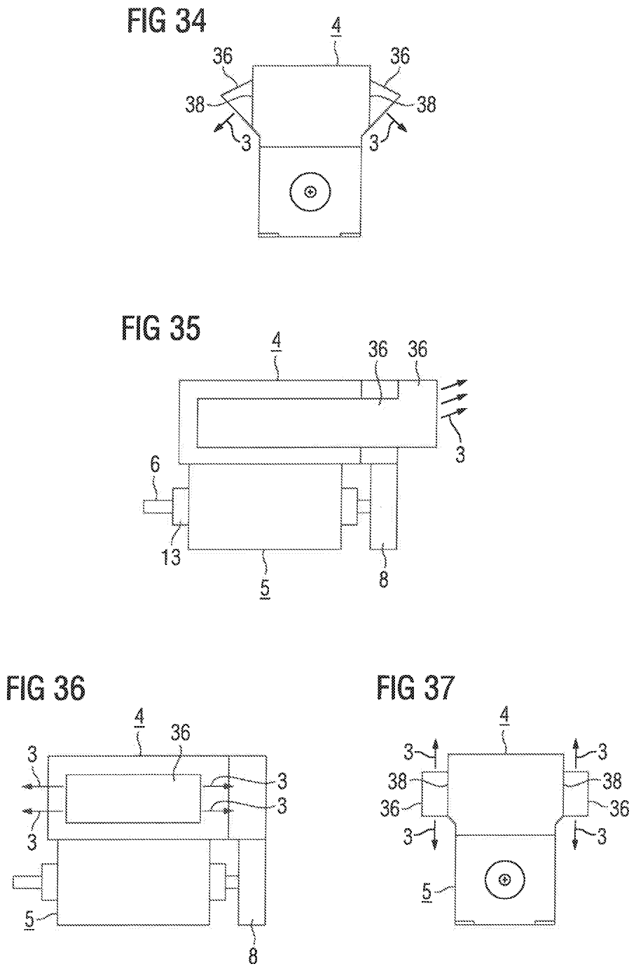

FIG. 34 to FIG. 37 show possible arrangements of optional air guidance element at the exit of the secondary circuit from the attachment cooler.

It should be pointed out that terms such as “axial”, “radial”, “tangential” etc. relate to the axis 7 used in the respective Figure or in the respective example described. In other words, the directions axial, radial, tangential always relate to an axis 7 of the rotor 18 and thereby to the corresponding axis of symmetry of the stator 17. In such cases “axial” describes a direction parallel to axis 7, “radial” describes a direction orthogonal to axis 7, towards this or away from it and “tangential” is a direction that is directed at a constant radial distance from axis 7 and with a constant axial position in the form of a circle around the axis 7. The expression “in the circumferential direction” is to be equated with “tangential”.

With regard to a surface, for example a cross-sectional surface, the terms “axial”, “radial”, “tangential” etc. describe the orientation of the normal vector of the surface, i.e. of that vector that is perpendicular to the surface concerned.

The expression “coaxial parts”, for example coaxial components, such as rotor 18 and stator 17, is understood here as parts that have the same normal vectors, thus for which the planes defined by the coaxial parts are parallel to one another. Furthermore, the expression should mean that the center points of coaxial parts lie on the same axis of rotation or symmetry. These center points can however lie on this axis possibly at different axial positions and the said planes can thus be at a distance of >0 from one another. The expression does not necessarily demand that coaxial assemblies have the same radius.

The term “complementary” means in conjunction with two components that are “complementary” to one another, that their external shapes are designed in such a way that the one component can preferably be arranged completely in the component complementary to it, so that the inner surface of the one component and the outer surface of the other component are ideally touching each other without gaps or over their entire surface. Consequently, in the case of two objects complementary to one another, the external shape of the one object is thus defined by external shape of the other object.

For reasons of clarity, partly in the cases in which parts are present multiple times, not all parts shown are provided with reference numbers in the figures.

The versions given below can be combined in any way. Likewise, individual features of the respective versions can also be combined, without departing from the spirit of the invention.

To avoid repetitions, in the description of versions already fundamentally shown with their reference numbers, the focus will only be on the supplementary or different features of the respective version.

FIG. 1 shows a module 1 of a plate heat exchanger, which has a hexagonal cross section, wherein the module 1 is designed hexagonally. The plates of the module 1 are arranged so that the airflows of a primary circuit 2 and of a secondary circuit 3 can exchange the heat in the module 1 via the plates.

FIG. 2 shows a module 1 of a plate heat exchanger that has a rectangular cross section, wherein the module 1 is designed as a cube shape or as a box shape. The plates of the module 1 are arranged so that airflows of the primary circuit 2 and secondary circuit 3 can exchange the heat in the module 1 via the plates.

What both versions have in common is that the modules 1 are composed of plates so that once the airflow of the primary circuit—i.e. the heated air, and thereafter the air of the secondary circuit—i.e. the heat-removing air, flows over neighboring plates in consecutive spaces.

The plate package of the respective modules 1 is sealed off from the outside and between the airflows by means of sealing elements. Likewise a glueing or a soldering of the plate package for sealing is conceivable. A packaging of the module 1 is created by clamping bolts or welded connections.

In order to intensify the exchange of heat between primary circuit 2 and secondary circuit 3 within a module 1, the plates are designed profiled, so that turbulences are formed in the respective airflow.

Furthermore, the cooling performance of the individual module 1 and of an attachment cooler 4 equipped therewith is able to be influenced by a same flow or counterflow principle of the primary circuit 2 and secondary circuit 3.

The sections of the airflows in the modules 1 of primary circuit 2 and secondary circuit 3 are shown merely by way of example in FIG. 1 and FIG. 2.

The airflows of the primary circuit 2 and secondary circuit 3 are formed by corresponding guidance apparatuses 12 in an attachment cooler 4.

FIG. 3 shows, in a longitudinal section, a dynamo-electric machine 5 with an attachment cooler 4. The dynamo-electric machine 5 is accommodated in a casing 26 that accepts the bearing 13. The casing 26 of the dynamo-electric machine 5 is designed closed and merely has predetermined openings—supply air channels 10 and waste air channels 11—to the attachment cooler 4, which allow a primary circuit 2 within the closed dynamo-electric machine 5.

A stator 17 is positioned in a torque-proof manner in the casing 26. The stator 17, in a groove, not shown in any greater detail, in its laminated core, has a winding system that, supplied with current, due to electromagnetic interactions via an air gap 25 of the dynamo-electric machine 5 with the rotor 18, brings about a rotation of the rotor 18 about its axis 7. The rotor 18 can have a short-circuit cage, so that the dynamo-electric machine 5 is embodied as a synchronous machine. The rotor 18 can also have permanent magnets, so that the dynamo-electric machine 5 is embodied as a synchronous machine (with full pole or salient pole armature).

Furthermore, it is possible to embody the rotor 18 with its own winding system, which obtains its electrical supply via a slip ring arrangement, for example.

Basically, the attachment cooler 4 is suitable for any conceivable type of dynamo-electric machine 5. It is merely necessary for the supply air channels 10 and waste air channels 11 in the casing 26 of the dynamo-electric machine 5 to be arranged with openings or cutouts correspondingly provided in terms of flow in the casing 15 of the attachment cooler 4.

The axially layered laminated core of stator 17 and rotor 18 is provided in this case at predeterminable spacings with radial channels 21 in order to improve cooling of, inter alia, the respective laminated core and of the winding system located in the grooves.

Furthermore, an internal fan 24 is provided, which conveys the air of the primary circuit 2. In this case a so-called one-sided ventilation is present, which is also referred to as Z ventilation.

One-sided ventilation refers to the ventilation of the dynamo-electric machine 5 in which an airflow (primary circuit 2) is fed on one side of the dynamo-electric machine 5 into a winding head space 14 and thereafter reaches the other winding head space 14 via various parallel and/or serial flow channels-winding head, rear of the laminated core of the stator 17, radial cooling channels 21, air gap 25, etc. From there the heated air of the primary circuit 2, via one or more fans-integral fans and/or separate fans-arrives in the attachment cooler 4 for re-cooling.

The air of the primary circuit 2 is thus routed via a winding head space 14 into the casing 26 of the dynamo-electric machine 5 and is routed there via the winding head 19 and the laminated core and/or the air gap 25 into the other winding head space 14. From there the now heated-up cooling airflow is cooled down again via the attachment cooler 4, in particular by the modules 1 arranged there by means of the secondary circuit 3.

In this and the further exemplary embodiments in some cases the primary circuits 2 and/or secondary circuits 3 are only shown in part, thus for example in FIG. 3 only one part of the primary circuit 2 above the axis 7 is shown. The primary circuit 2 or a part thereof likewise runs in the lower section, and also in other areas of the interior of the dynamo-electric machine 5, such as in air gap 25 for example.

The casing 15 of the attachment cooler 4 has sound-deadening elements inter alia in order to reduce noise emissions in the environment of the dynamo-electric machine 5.

A fan 8 generates a flow of cooling air of the secondary circuit 3, which cools the heated cooling airflow of the primary circuit 2 back down via the plate heat exchangers of the module 1.

In this case the fan 8 is an integral fan which is connected to the shaft 6 in a torque-proof manner. Instead of this or also as an addition to it, a separate fan 31 at and/or on the attachment cooler 4 is possible, in order to support the cooling airflow of the secondary circuit 3.

The modules 1, as can also be seen in FIG. 4, are preferably arranged along a central channel 20, which extends, at least in sections, in parallel to the axis. In this form of embodiment the modules 1 are arranged on both sides along the central channel 20.

The basic arrangement of the plates of the module 1 illustrated is only intended to show the basic representation of plate coolers of the module 1, but not necessarily a direction of flow of primary circuit 2 and/or secondary circuit 3 defined thereby.

A one-sided arrangement of modules 1 with a central channel 20 running asymmetrically is also conceivable (FIG. 29, FIG. 30). In this case the modules 1 have a greater depth in order to improve the exchange of heat between primary circuit 2 and secondary circuit 3.

FIG. 5 shows, in a perspective diagram, the attachment cooler 4 on the casing 26 of the dynamo-electric machine 5. In this figure the modules 1, which are embodied as hexagonal or—as in this case—cuboid plate coolers, are shown, for illustrative reasons, taken out of their preferably complementary, receiving openings 22. Each of the modules 1 can be taken out individually, for the purpose of cleaning the plates or for exchange, without a bypass in terms of flow being created by the unoccupied receiving opening 22, which adversely affects the cooling performance of the remaining modules 1.

Furthermore, there can be access to the dynamo-electric machine 5 via the insertion cavities or receiving openings 22 of the modules, without, as previously, taking the attachment cooler 4 away from the machine 5.

Openings are present in the casing 15 of the attachment cooler 4, which are embodied to be complementary to the supply air channels 10 and waste air channels 11 in the casing 26 of the dynamo-electric machine 5, so that a closed primary circuit 2 is set up. Moreover, further guidance apparatuses 12 are also arranged in the casing 15 in order to embody primary circuit 2 and secondary circuit 3.

FIG. 6 shows an attachment cooler 4 of a dynamo-electric machine 5 with a two-sided ventilation of the primary circuit 2 shown in basic—also known as X ventilation. In this case, by comparison with the version in accordance with FIG. 3, the plate 35 is removed, which inter alia, as well for an adaptation of guidance apparatuses 12 in the attachment cooler 4 is necessary for the one-sided ventilation.

Two-sided ventilation refers to the ventilation of the dynamo-electric machine 5 in which an airflow (primary circuit 2) is fed on both sides of the dynamo-electric machine 5 into the winding head space 14 and thereafter via various parallel and/or serial flow channels—winding head, rear of the laminated core of the stator 17, radial cooling channels 21, air gap 25, etc.—essentially centrally to the rear of the stator laminated core into the attachment cooler 4. The heated air of the primary circuit 2 is conveyed by one of more fans-integral fans or separate fans-into the attachment cooler 4 for cooling it back down. Appropriate guide plate elements 29 improve the course of the flow of the primary circuit 2.

FIG. 7 shows, in an overhead view onto the attachment cooler 4, a principal course of the airflow of the secondary circuit 3. In this figure an airflow is pushed by an integral fan 8 and/or a separate fan 31 axially via a supply air channel 37 into the central channel 20, which, via plate heat exchangers of the modules 1, cools air of the primary circuit 2 back down and exits the casing 15 of the attachment cooler 4 via the waste air channels 38 in a heated-up state.

In this case it should be noted that both the supply air channels 37 and also the waste air channels 38 of the attachment cooler 4 can be embodied not just in the shape of channels, but also merely as openings in the casing 15 of the attachment cooler 4.

FIG. 8 shows an attachment cooler 4 of a dynamo-electric machine 5 with basic a one-sided ventilation of the primary circuit 2 illustrated-which is also referred to as Z ventilation. In this figure the heated air of the primary circuit 2 is first directed upwards in the attachment cooler 4, in order to then be cooled down again via the module 1 on its “way” downwards.

FIG. 9, in a view from above onto the attachment cooler 4, shows a basic course of the airflow of the secondary circuit 3. In this figure an airflow is sucked axially out of the central channel 20 by an integral fan 8 and/or a separate fan 31. The airflow of the primary circuit 2 is thus cooled down again via plate heat exchangers of the modules 1. The integral fan 8 in this case sucks the airflow of the secondary circuit 3 through the module 1. It is however likewise possible for the integral fan 8 to push the air from the environment outwards over the modules 1.

FIG. 10 shows a further possibility for using the inventive attachment cooler 4 for a two-sided ventilation of the dynamo-electric machine 5. In the present example the first receiving opening 22 is not occupied. Through this, in terms of flow, the guidance apparatuses 12 of the attachment cooler 4 are positioned so that the primary circuit 2 continues to remain closed.

FIG. 11 shows the design of the secondary circuit 3 corresponding thereto, the non-occupied receiving openings 22 of which are blocked for the secondary circuit 3 in order to avoid a short circuit in terms of flow.

FIG. 12 shows a basic longitudinal section of the attachment cooler 4 and of the dynamo-electric machine 5, wherein a separate fan 31 is positioned on the attachment cooler 4 for the secondary circuit 3. The separate fan 31, in particular an axial fan, is connected in terms of flow via a hood 32 to the secondary circuit 3. The primary circuit 2 is routed as single-flow in the machine and in the attachment cooler 4 (i.e. as Z ventilation).

FIG. 13 shows this form of embodiment in a part cross-section of the attachment cooler 4 and of the dynamo-electric machine 5, wherein the separate fan 31 supplies the secondary circuit 3 with air via the supply air channel 37 and the central channel 20.

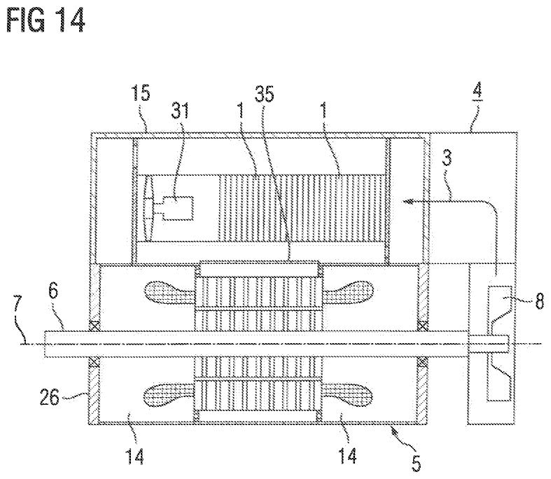

FIG. 14 shows a basic longitudinal section of the attachment cooler 4 and of the dynamo-electric machine 5, wherein an integral fan 8 drives the airflow of the secondary circuit 3 and an additional separate fan 31 is positioned in the central channel 20, which contributes to maintaining the airflow in the secondary circuit 3. The primary circuit 2 is again embodied as a single flow and the airflows over the modules 1 in series or in parallel.

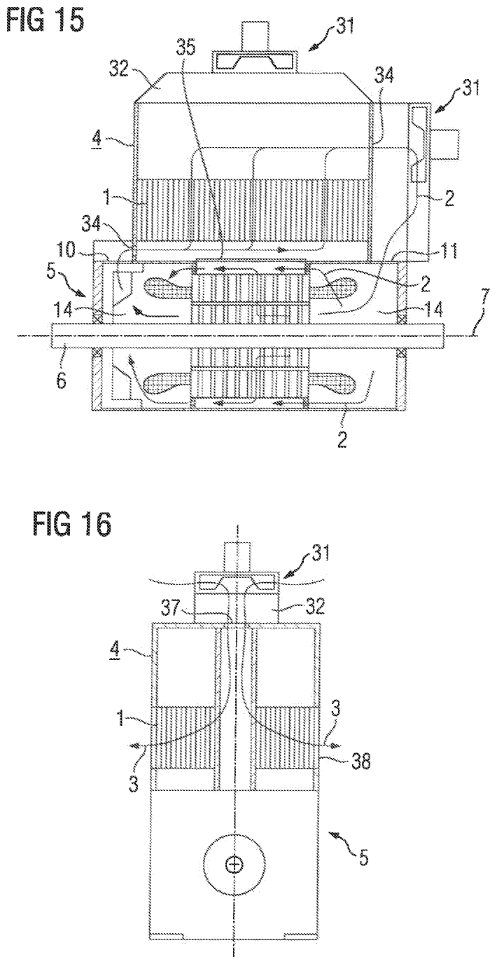

FIG. 15 shows a basic longitudinal section of the attachment cooler 4 and of the dynamo-electric machine 5, wherein the secondary circuit 3, as in FIG. 12, is driven by a separate fan 31. The primary circuit 2 embodied with a single flow is likewise driven by a separate fan 31. In this case air guidance channels in the attachment cooler 4, in particular of the primary circuit 2 are to be adapted accordingly compared to an integral ventilation of the primary circuit 2. In this case air guided from below into the modules 1 of the primary circuit 2 is guided upwards, in particular radially upwards and on the way there is cooled back down via the modules 1.

FIG. 16 shows this form of embodiment according to FIG. 15 in a part cross-section of the attachment cooler 4 and of the dynamo-electric machine 5, wherein the separate fan 31 supplies the secondary circuit 3 with air via the central channel 20. This airflow flows past the modules 1 of the attachment cooler 4 in parallel.

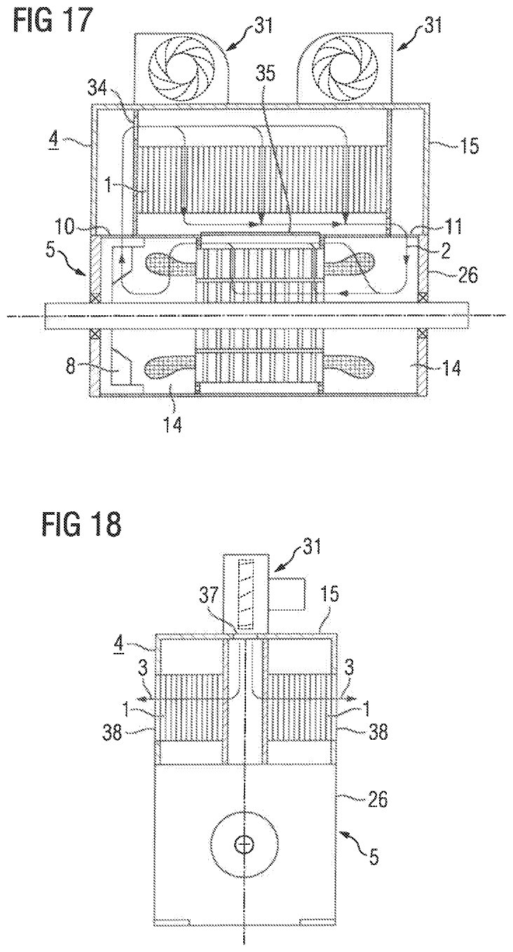

FIG. 17 shows a basic longitudinal section of the attachment cooler 4 and of the dynamo-electric machine 5, wherein the secondary circuit 3 is driven by two separate fans 31. These are positioned at the top above the attachment cooler 4. The primary circuit 2 is again embodied as a single flow.

FIG. 18 shows this form of embodiment according to FIG. 17 in a part cross-section of the attachment cooler 4 and of the dynamo-electric machine 5, wherein the separate fan 31 supplies the secondary circuit 3 with air via the central channel 20.

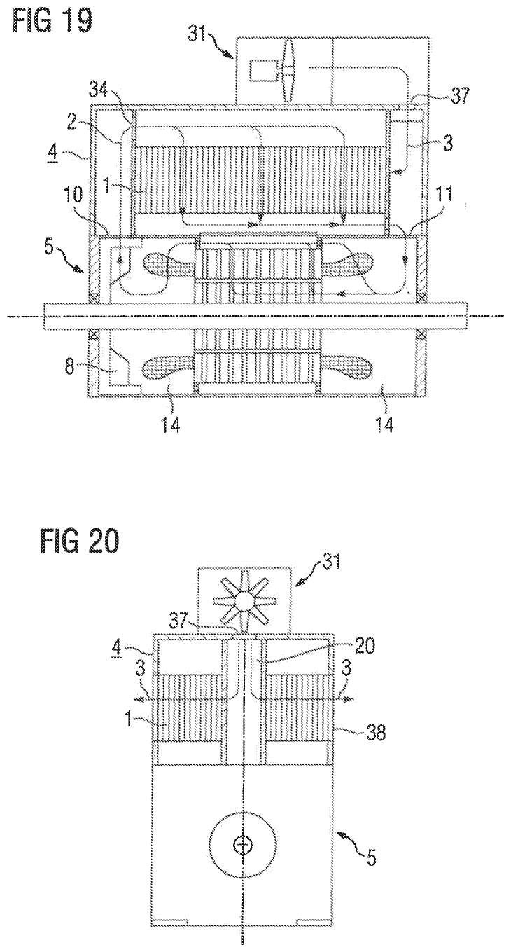

FIG. 19 shows a basic longitudinal section of the attachment cooler 4 and of the dynamo-electric machine 5, wherein the secondary circuit 3 is driven by a separate fan 31, which is embodied as an axial fan and is positioned on the attachment cooler 4. The airflow of the secondary circuit 3 is fed via redirection . . . channels on the end face side of the attachment cooler 4 into the central channel 20. The primary circuit 2 embodied as a single flow is driven by an integral fan 24 positioned on the shaft 6.

FIG. 20 shows this form of embodiment according to FIG. 19 in a part cross-section of the attachment cooler 4 and of the dynamo-electric machine 5.

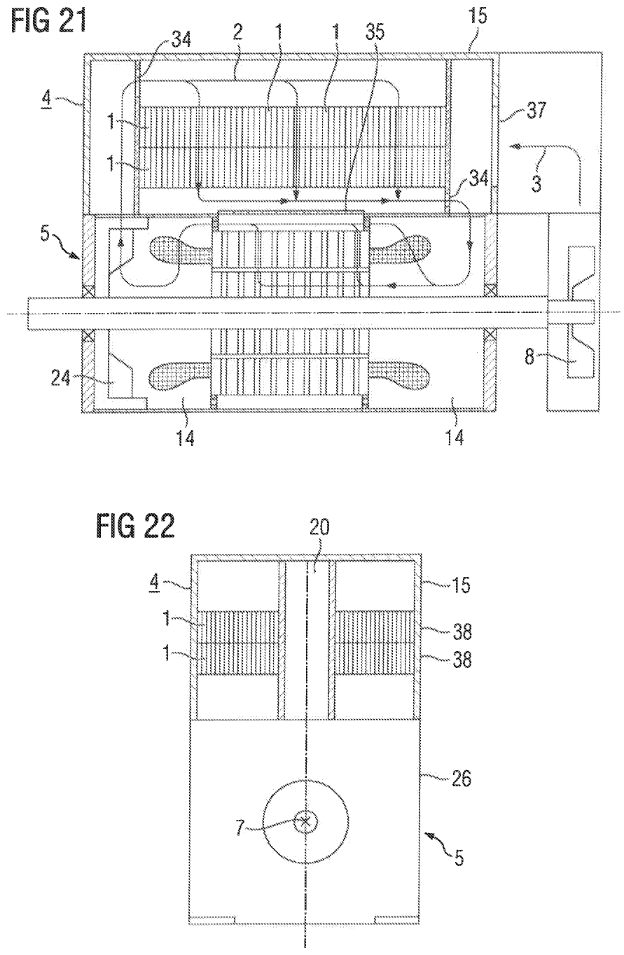

FIG. 21 shows a basic longitudinal section of the attachment cooler 4 and of the dynamo-electric machine 5, wherein the secondary circuit 3 is driven by a fan 8, which is connected in a torque-proof manner to the shaft 6 of the dynamo-electric machine 5 and is located outside of the casing 26. The primary circuit 2 embodied as a single flow is driven by an integral fan 24 positioned on the shaft 6. What is decisive with this version is that the modules 1 are not only arranged in an axially aligned series, but are also able to be arranged above one another and/or behind one another (as shown in FIG. 22), provided the receiving openings 22 of the attachment cooler 4 allow this. In this case the airflow of the primary circuit 2 flows in parallel and/or in series in modules 1.

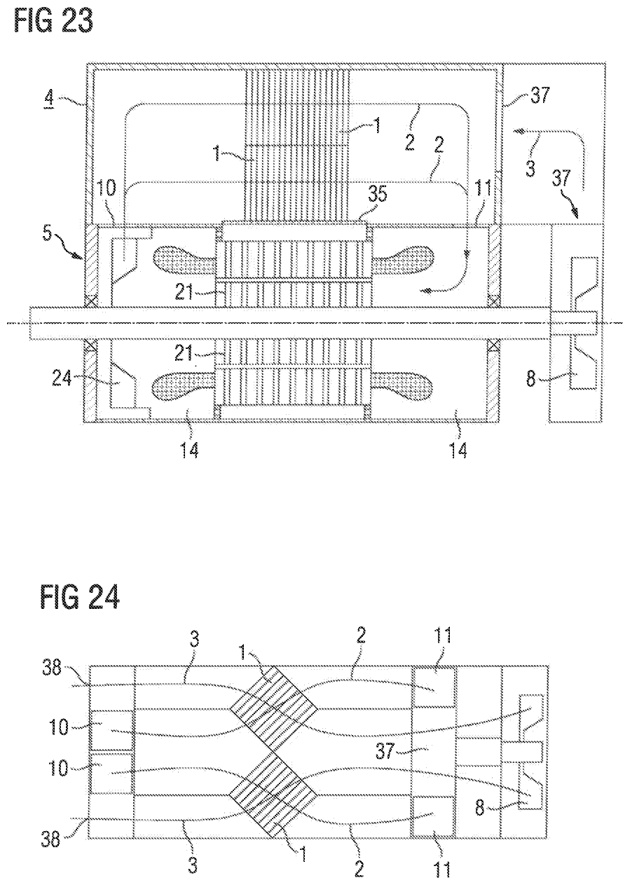

FIG. 23 shows, in a basic longitudinal section of the attachment cooler 4 and of the dynamo-electric machine 5, a further arrangement of modules 1 in an attachment cooler 4. The primary circuit 2 is split up, wherein each part flow flows through the respective modules 1 of the plate cooler in series. Thereafter the airflow cooled back down is merged and fed to the dynamo-electric machine 5 via the waste air channels 11.

This version shows inter alia that the modules 1 can occupy the space within the attachment cooler 4—depending on the specification of receiving openings 22—in almost any given way. This means that, in the height and also in the depth and in the axial alignment, practically no spatial restrictions are specified, if one excludes the flow channels of primary circuit 2 and secondary circuit 3 and also the guidance apparatuses 12.

FIG. 24 shows a further possible course of the primary circuit 2 and secondary circuit 3, as well as an angled arrangement of modules 1. The primary circuit 2 arrives, because of the integral fan 24, from one or more air supply channels 10 into the attachment cooler 4 and after the heat exchange by the modules 1 of the plate cooler via the waste air channel 11 enters into the casing 26 of the dynamo-electric machine 5 cooled down again.

FIG. 25 shows a structure of the attachment cooler 4 and of the dynamo-electric machine 5, similar to FIG. 19. An opening in the attachment cooler 4 is merely provided radially above the stator 17, so that, taking into consideration the two integral fans 24 and their cover elements 29, a double-flow is set up radially below the winding head 19, as is shown greatly simplified. The secondary cooling circuit 3 (as is shown from example in FIG. 26) cools in accordance with the same method according to FIG. 19.

FIG. 27 shows a secondary airflow 3 that, regardless of how it is created (separate fan 31 and/or integral fan 8) is routed via the central channel 20 to the respective modules 1. The secondary airflow 3 therefore flows through the individual modules 1 in parallel. Each module 1 in this case provides an almost similar cooling performance, since the secondary airflow 3, before it enters into the respective module 1, has practically the same temperature.

FIG. 28 shows two individual secondary airflows 3, which flow through the modules 1 in series. The cooling power per module 1 falls in this case as the temperature of the secondary airflow 3 increases.

FIG. 29 shows a part cross-section of the attachment cooler 4 and of the dynamo-electric machine 5, wherein as regards the arrangement of the modules 1, the attachment cooler 4 is embodied asymmetrically to the central channel 20. In this case the modules 1 are now embodied deeper. This can be an advantage when the modules 1 are only accessible from one side (here from the right) for possible maintenance.

FIG. 30 shows this structure in a cutaway overhead view, in this case the modules 1 are embodied longer in their extent perpendicular to the axis 7.

FIG. 31 and FIG. 32 show examples of arrangements of the attachment cooler 4 in respect of the dynamo-electric machine 5 to be cooled. Taking into account possible guidance apparatuses 12, supply lines 33 etc., the attachment coolers 4 are able to be arranged directly alongside, on or below the dynamo-electric machine 5. It is likewise possible to set up the attachment coolers 4 in another room. In this case the primary cooling airflow 2 is then to be routed accordingly via supply lines 33.

Another embodiment of the central channel 20 is also conceivable in accordance with FIG. 33.

FIGS. 34 to 37 show examples of possibilities for guiding the heated waste air of the secondary circuit 3, which is coming out of the waste air channel 38, i.e. out of the modules 1.

Specific guidance elements 36 in this case guide this waste air obliquely downwards (FIG. 34), or initially in a direction in parallel to the axis and then optionally obliquely upwards (FIG. 35). Alignments of the guide elements 36 parallel to the axis are likewise conceivable, which guide the heated waste air of the secondary circuit 3 in the one and/or other direction in accordance with FIG. 36.

Appropriate alignments of the guide elements 36 can also guide the heated waste air of the secondary circuit 3 upwards and/or downwards in accordance with FIG. 37.

FIG. 34 to FIG. 37 show a direction of the waste air. This direction can likewise be reversed, in that for example the direction of flow of the secondary circuit 3 is reversed. This is achieved for example by other directions of rotation of separate fans 31 of the secondary circuit 3.

Plastics, aluminum, steel, copper or stainless steel are suitable as materials for the plates of the modules 1. It is likewise conceivable to provide the plates of the modules 1 with an epoxy coating, or with further coatings.

Likewise these plates can be embodied flat or corrugated.

In order to create a sound deadening of the attachment cooler 4, the interior of the casing 15 and/or the air outflow surfaces of the secondary circuit 3 are aligned and/or provided, at least in sections with sound-deadening elements, without adversely affecting the cooling performance of the attachment cooler 4.

Through the inventive embodiment of the attachment cooler 4 all known forms of construction are possible, in that the dynamo-electric machine 5 is able to be set up vertically, horizontally or inclined at a predeterminable angle. (IM1001 . . . ).

Through the inventive embodiment of the attachment cooler 4 all known cooling types, such as IC611, IC616, IC666, IC661 etc. are also furthermore able to be implemented.

The attachment cooler 4 does not absolutely have to be arranged on the machine 5. It can likewise also be arranged to the side of the machine or even below the machine or in a separate adjacent room, as can be seen for example from FIG. 31 and FIG. 32.

The shaft-mounted fans 24 of the primary circuit 2 arranged within the casing 26 can be arranged, independently of the type of cooling (Z or X ventilation), on the side facing towards a working machine and/or on the side facing away from a working machine within the casing 26 of the dynamo-electric machine 5. (i.e. the DE (Drive-End) side or NDE (Non-Drive-End) side).

This also basically applies to fans 8, which—where provided—can likewise by arranged on the DE side and/or NDE side of the dynamo-electric machine 5.

The primary circuit 2 and/or the secondary circuit 3 can flow through at least individual modules 1 in series or in parallel. This will be guaranteed by guidance apparatuses 12 provided for this purpose.

In order to maintain the secondary circuit 3 and/or the primary circuit 2, as an addition to or on its own, at least one separate fan 31 can be provided, which pushes the amount of air required or sucks it through the secondary circuit 3.

These separate fans 31 can—as stated above—be arranged at practically any given points of the primary circuit 2 and/or secondary circuit 3.

This inventive attachment cooler 4 is also suitable for systems protected against explosions. In this case extra attention is to be given where necessary to sealing the gap 28, in particular between the modules 1, in order to prevent a possibly explosive gas getting into the primary circuit 2—and thus into the winding system.

As well as air, other gaseous media, such as for example nitrogen are also possible as cooling medium of the primary circuit 2 and/or secondary circuit 3. Liquid cooling media, such as oil or water, are also conceivable for the primary circuit 2 and/or secondary circuit 3. The decisive factor is always the exchange of heat between primary circuit 2 and secondary circuit 3 via the modules 1 of the attachment cooler 4, which are designed as plate coolers.

1.-13. (canceled)

14. An attachment cooler of a dynamo-electric machine, said attachment cooler being embodied as a heat exchanger and comprising:
a primary circuit for flow of a medium;
a secondary circuit separate from the primary circuit for flow of a medium, said secondary circuit including a central channel and a waste air channel;
a casing including receiving openings and designed to accommodate the central channel and the waste channel of the secondary circuit, with the waste channel leading out to a side of the casing; and
exchangeable modules embodied as plate heat exchangers and insertable in the receiving openings of the casing, each of the modules designed for individual removal, without a flow bypass being created by unoccupied ones of the receiving openings.

15. The attachment cooler of claim 14, wherein the central channel extends parallel to an axis of the casing.

16. The attachment cooler of claim 14, wherein the central channel runs in a center of the casing.

17. The attachment cooler of claim 14, wherein the waste air channel leads out of the casing to a side of the casing in perpendicular relation to a supply air channel.

18. The attachment cooler of claim 14, wherein the central channel is designed to accept an airflow created by an integral fan or separate fan arranged directly on the dynamo-electric machine.

19. The attachment cooler of claim 14, wherein the secondary circuit is designed to be open so as to be operable with ambient air.

20. The attachment cooler of claim 14, wherein the casing includes supply air openings and waste air openings of both the primary circuit and the secondary circuit.

21. The attachment cooler of claim 14, wherein the casing includes guidance apparatuses of both the primary circuit and the secondary circuit.

22. The attachment cooler of claim 14, wherein at least one of the primary circuit and the secondary circuit flows through the modules in series and/or in parallel.

23. The attachment cooler of claim 14, wherein the primary circuit and the secondary circuit are designed to enable an exchange of heat between plates of the modules.

24. The attachment cooler of claim 23, wherein the plates are aligned perpendicular to an axis of the casing.

25. The attachment cooler of claim 14, further comprising an air filter arranged upstream of the secondary circuit.

26. The attachment cooler of claim 25, wherein the air filter is arranged upstream of the central channel.

27. The attachment cooler of claim 14, wherein the modules are arranged in parallel and/or in series in at least one of the primary circuit and the secondary circuit in flow direction of the medium.

28. A dynamo-electric machine, comprising:
a stator including a winding system;
a rotor interacting with the stator to cause the rotor to rotate about an axis;
an attachment cooler embodied as a heat exchanger for cooling the stator and the rotor, said attachment cooler comprising a primary circuit for flow of a medium, a secondary circuit separate from the primary circuit for flow of a medium, said secondary circuit including a central channel and a waste air channel, a casing including receiving openings and designed to accommodate the central channel and the waste channel of the secondary circuit, with the waste channel leading out to a side of the casing, and exchangeable modules embodied as plate heat exchangers and insertable in the receiving openings of the casing, each of the modules designed for individual removal, without a flow bypass being created by unoccupied ones of the receiving openings; and
a casing including openings, which correspond to supply air and waste air openings of the attachment cooler such as to set up the primary circuit such that the primary circuit is able to be cooled back down via a cooling airflow of the secondary circuit.

29. The dynamo-electric machine of claim 28, further comprising a separate fan or an integral fan designed to cause a cooling airflow of the primary circuit and/or the cooling air flow of the secondary circuit.

30. The dynamo-electric machine of claim 28 for use in a compressor such that cooling performance is adapted depending on use and installation location via volume flows and number and/or type of the modules of the attachment cooler.

31. A method for cooling a dynamo-electric machine, the method comprising:
detecting a cooling temperature in at least one of the primary circuit and secondary circuit of an attachment cooler as set forth in claim 14;
transferring data relating to the cooling temperature to a closed-loop control apparatus for controlling a speed of separate fans and/or for setting guidance apparatuses of the attachment cooler and/or of the dynamo-electric machine.

32. The method of claim 31, further comprising:
creating an airflow by an integral fan or separate fan arranged directly on the dynamo-electric machine; and
conducting the airflow through the central channel of the secondary circuit.

33. The method of claim 31, further comprising designing the secondary circuit to be open so as to be operable with ambient air.
